(19) United States
(12) Patent Application Publication
(10) Pub. No.: US 2008/0133440 A1
(43) Pub. Date: Jun. 5, 2008

(54) SYSTEM, METHOD AND PROGRAM FOR DETERMINING WHICH PARTS OF A PRODUCT TO REPLACE

(75) Inventors: Donald A. Bray, Endicott, NY (US); Peter Stewart Kirkaldy, Afton, NY (US); Steven Sedelmeyer, Endicott, NY (US)

Correspondence Address: IBM CORPORATION, IPLAW SHCB/40-3, 1701 NORTH STREET, ENDICOTT, NY, 13760, US

(73) Assignee: International Business Machines Corporation, Armonk, NY (US)

(21) Appl. No.: 11/566,968

(22) Filed: Dec. 5, 2006

(51) Int. Cl. G06N 5/00

(52) U.S. Cl. 706/45

(57) ABSTRACT

A computer system, method and program product for determining an order to replace parts of a product in response to a problem with the product. Determinations are made as to a most likely one of the parts to have failed and caused the problem with the product and a next most likely one of the parts to have failed and caused the problem with the product. A determination is also made if the one part was already replaced within a predetermined period. If so, the one part is not recommended for replacement and instead the next part is recommended for replacement. If not, the one part is recommended for replacement.

### FIELD OF THE INVENTION

The invention relates generally to computer systems, and more specifically to a computer system for determining which parts or a product to replace.

### BACKGROUND OF THE INVENTION

Computer systems and other products are comprised of many parts, and occasionally a part fails. Often, a repair person attempts to troubleshoot the problem and identifies one or more parts that may have failed. Then, the repair person replaces the parts that may have failed, one at a time, to attempt to fix the system. The repair person typically replaces first the part which is most likely to have failed. If that does not fix the problem, the repair person will then replace the part which is second most likely to have failed. Program tools were known to determine the parts which have most likely failed and their order of likelihood of failure, based on the symptoms. For example, an IBM Problem Analysis program tool was known to determine which part has most likely failed based on the symptoms, and assign a score to each part which may have failed. The score for each such part indicates the likelihood of failure of the part. Parts are often expensive, and sometimes time consuming to replace, and there is also time to reboot and test the computer or other product. Also, once a part is replaced and found not to have corrected the problem, typically the replaced part is left in the product. Ideally, the failed part is identified and replaced first, or at least early, in the sequence.

It is more difficult to troubleshoot an intermittent problem, and this may lead to replacement of additional parts. Consider the following example. A problem is identified, and a problem determination tool determines that Part A is most likely to have failed. So, the repair person replaces Part A, and then tests the system. In some cases, the problem will appear to be fixed, but only because the problem is intermittent and not visible at the time. When the same problem occurs later, the problem determination tool will once again determine that Part A is most likely at fault, so the repair person will replace Part A again. However, in neither case was Part A the part which had failed.

An object of the present invention is to determine an optimum order to replace parts which may have failed, in an attempt to fix a problem with a product.

### SUMMARY OF THE INVENTION

The present invention resides in a computer system, method and program product for determining an order to replace parts of a product in response to a problem with the product. Determinations are made as to a most likely one of the parts to have failed and caused the problem with the product and a next most likely one of the parts to have failed and caused the problem with the product. A determination is also made if the one part was already replaced within a predetermined period. If so, the one part is not recommended for replacement and instead the next part is recommended for replacement. If not, the one part is recommended for replacement.

The present invention also resides in a computer system, method and program product for determining an order to replace parts of a product in response to a problem with the product. A determination is made as to a most likely one of the parts to have failed and caused the problem with the product and a first score corresponding to a likelihood that the one part has failed. A determination is also made as to a next most likely one of the parts to have failed and caused the problem with the product and a second score corresponding to a likelihood that the next part has failed. A higher score indicates a greater likelihood that the corresponding part has failed. A determination is also made if the one part was already replaced within a predetermined period. If so, the first score is decreased by a predetermined amount or percentage and/or the second score is increased by a predetermined amount or percentage or fraction thereof. If not, the first score and second score are maintained without change. A recommendation is made to first replace whichever of the first part or the second part has a higher score after the foregoing adjustments.

### BRIEF DESCRIPTION OF THE FIGURES

FIG. 1 is block diagram of a product repair management system, including a guided repair program, in which the present invention is incorporated.

FIGS. 2(A) and 2(B) forma flow chart of one embodiment of the guided repair program of FIG. 1.

FIGS. 3(A) and 3(B) form a flow chart of another embodiment of the guided repair program of FIG. 1.

### DETAILED DESCRIPTION OF THE PREFERRED EMBODIMENTS

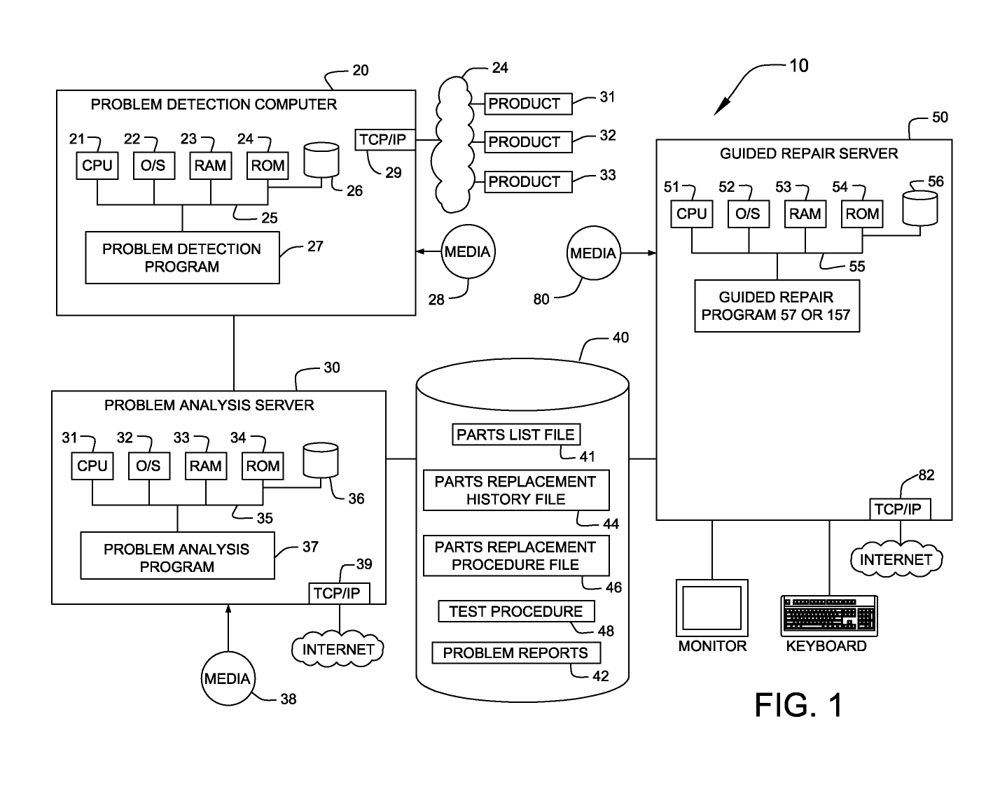

The present invention will now be described in detail with reference to the figures. FIG. 1 illustrates a product repair management system generally designated 10 according to the present invention. System 10 includes a known problem detection computer 20 which is coupled to products such as computer hardware devices 31-33 such as (computers, peripheral devices, storage controllers and devices, routers, firewalls, etc.) via one or more networks 24 to detect problems in such devices. Computer 20 includes known CPU 21, operating system 22, RAM 23, ROM 24 on a common bus 25 and storage 26, and a problem detection program 27. Problem detection program 27 detects the problems and their nature from SNMP traps, hardware logic checking or parity errors from the devices 31-33 (or intervening network management systems). Upon receipt of the problem notification or periodically, problem detection program 27 sends the raw data describing the problem to a problem analysis server 30. Problem analysis server 30 includes known CPU 31, operating system 32, RAM 33, ROM 34 on a common bus 35 and storage 36, and a problem analysis program 37. In response to receipt of the raw data describing the problems, problem analysis program 37 processes the raw data to generate a report describing the problem, and writes the report into a problem report file 42 in a storage 40. By way of example, problem analysis program 37 processes the raw data by correlating error data from multiple subsystems. For example, consider a failure of a hardware component in a power subsystem which is reported to the problem analysis program. This failure in the hardware component also causes a momentary voltage spike. The voltage spike causes failures in CPU hardware and other subsystems, which are also reported to the problem analysis program. Consequently, the problem analysis program sees multiple error reports within a short period of time. The problem analysis program is programmed to ignore errors from other subsystems after an error in the power subsystem. As a result, the problem analysis program generates a problem report identifying the power subsystem as the failure that needs to be repaired, and includes the list of power parts in the report. There still remains a failure in the CPU hardware or other subsystems that will not be repaired during the first iteration.

System 10 also includes a guided repair server 50. Server 50 includes known CPU 51, operating system 52, RAM 53, ROM 54 on a common bus 55 and storage 56, and a guided repair program 57 according to the present invention. Guided repair program 57 determines and initiates display of an optimum order to replace parts of the problematic product to correct the problem, determines and initiates display of a procedure for replacing each part, determines and initiates a procedure for testing whether each replaced part has corrected the problem, and records in a Parts Replacement History File 44 which parts have been replaced and whether they appeared to have fixed the problem as indicated by the repair person.

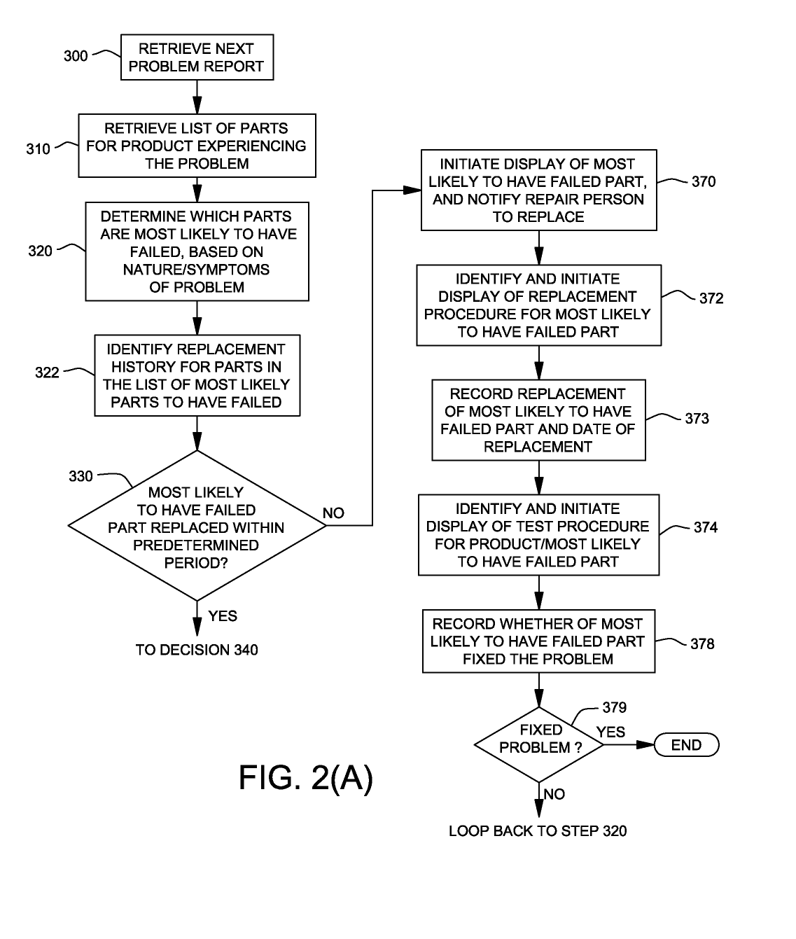

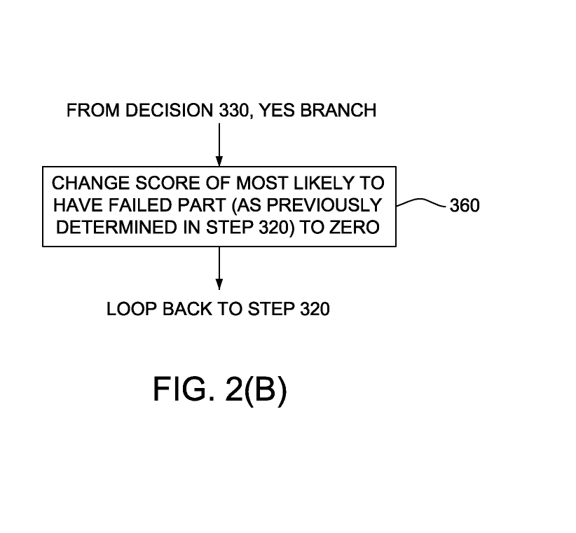

FIGS. 2(A) and 2(B) illustrate the operation and function of guided repair program 57 in more detail in accordance with one embodiment of the present invention, to correct a problem with a product. In step 300, program 57 retrieves a next program report (for a current problem at issue) from file 42. The report identifies a device, such as a computer 31, for which a problem has been reported and the nature/symptoms of the problem. Next, program 57 retrieves from a Parts List file 41 a list of parts within computer 31 that can be replaced (step 3 10). Next, program 57 makes a preliminary determination, based on a known algorithm, of the most likely parts (such as Parts A, B and C) in the computer to have failed (based on the nature/symptoms of the problem) and thereby caused the problem with computer 31. In step 320, program 57 also assigns a score to each such part which may have failed, where the higher the score the greater the likelihood that the part has failed. For example, Part A may have a score of “70%”, Part B may have a score of “20%”, and Part C may have a score of “10%”. Next, program 57 identifies from the parts replacement history file 44 list if the most-likely to have failed part (i.e. the one with the highest score in this case Part A) has been replaced in the last predetermined period, such as thirty days (step 322 and decision 330). If not (decision 330, no branch), then program 57 determines that the most-likely to have failed part, as preliminarily determined in step 320, should be replaced first, and proceeds to initiate display of this most-likely to have part as the part to replace first (step 370). In the foregoing example, Part A is the most likely part to have failed, and because Part A has not been replaced in the last thirty days, program 57 recommends replacement of Part A. Next, program 57 identifies from a Parts Replacement Procedure File 46 and initiates display of a procedure for replacing the part most likely to have failed (step 372). This procedure is a step-by-step process for removing the old part and installing the replacement part. After the repair person replaces the part, the repair person notifies program 57, and program 57 records in file 44 that the part has been successfully replaced and the date of replacement (step 373). Also, program 57 identifies from a Test Procedure File 48 and initiates display of a procedure for testing whether the replaced part has corrected the problem (step 374). In response, the repair person tests whether the replacement of the part appears to have fixed the problem, and afterwards, notifies program 57 of the results. In response, program 57 records in the corresponding problem report whether the replacement of the part appeared to have fixed the problem (step 378). If the replacement of the part appears to have fixed the problem, i.e. the product passes the test (decision 379, yes branch), then the repair process is complete. However, if the replacement of the part has not fixed the problem (decision 379, no branch), then program 57 loops back to step 320 to process the same problem report again. In step 320, program 57 makes a preliminary determination, based on a known algorithm, of the most likely parts (such as Parts A, B and C) in the computer to have failed (based on the nature/symptoms of the problem) and thereby caused the problem with computer 31. In step 320, program 57 also assigns a score to each such part which may have failed, where the higher the score the greater the likelihood that the part has failed. For example, Part A may still have a score of “70%” (because the algorithm of step 320 is based on the nature/symptoms of the problem, not the replacement history), Part B may have a score of “20%”, and Part C may have a score of “10%”. Next, program 57 identifies from the parts replacement history file 44 list if the most-likely to have failed part (i.e. the one with the highest score, in this case Part A) has been replaced in the last thirty days (step 322 and decision 330).

In this second iteration of program 57 where Part A was just replaced, the answer to decision 330 is “yes”. Likewise, if Part A was replaced earlier, but in the last thirty days, the answer to decision 330 in the first iteration of program 57 is also “yes”. If so (decision 340, yes branch), program 50 changes the score of the part with the highest score, i.e. Part A in this example that was replaced in the last thirty days, to zero (step 360). Next, program 57 loops back to step 320 to recompute the new list of most likely to have failed parts and their respective scores. Typically, this will be the same list and the same order as during the previous iteration of step 320 except that Part A will be moved to the end of the list. Also, the scores of the parts in the new list can be increased proportionately to share the score of the first part in the original list. For example, in the new list, Part B may have a score of 66% and Part C may have a score of 33% because without Part A, Part B is twice as likely to have failed as Part C. Next, program 57 determines the first part on the new list, i.e. the most likely to have failed part after Part A has been moved to the end of the list. In the illustrated example, this will be Part B. Next, program 57 repeats the foregoing steps one or more iterations until a part is replaced and appears to have fixed the problem. For example, if Part B has not been replaced in the last thirty days (decision 330, no branch), then program 57 will recommend replacement and guide replacement of Part B. Consider the case of an intermittent problem where the replacement of Part A during the first iteration of program 57 appears to have fixed the problem as determined from a successful test of the product in step 374 after replacement of Part A. However, replacement of Part A has not really fixed the problem, and the same problem appears again within thirty days. In such a case, Part A will not be replaced again. Instead, Part B will be replaced during the second iteration (assuming Part B was not replaced within the last thirty days), and Part B will most likely fix the problem during the second iteration. Referring again to decision 330, yes branch, where Part B was replaced in the last thirty days (decision 330, yes branch), then the score of Part B will also be changed to zero in step 360, and Part C will then have the highest score (as determined in the next iteration of step 320), and be replaced in the next iteration of step 370, assuming it was not replaced in the last thirty days.

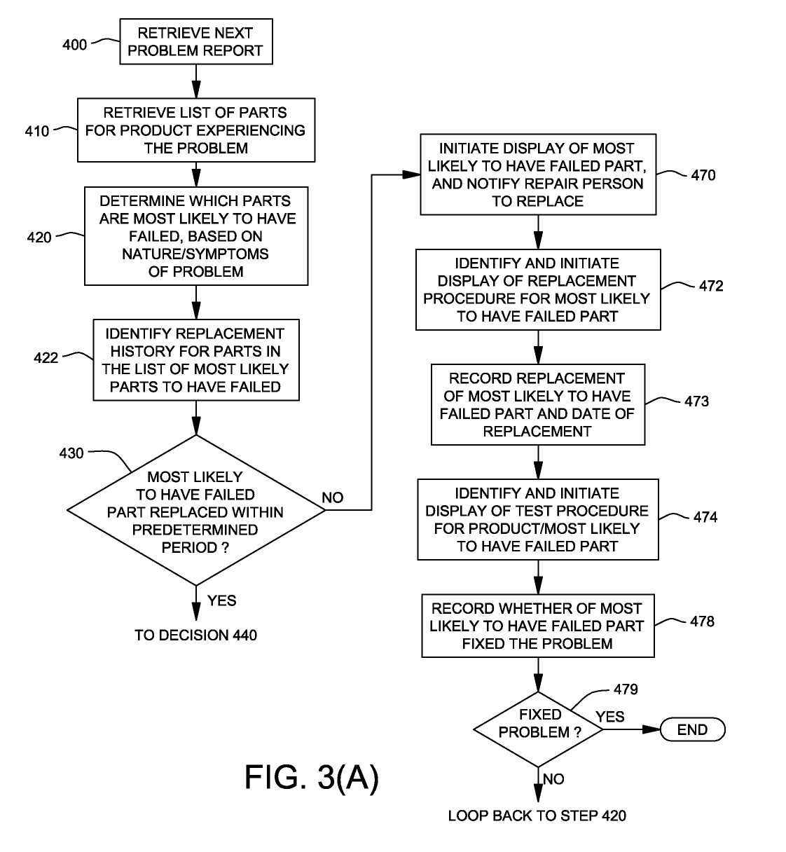

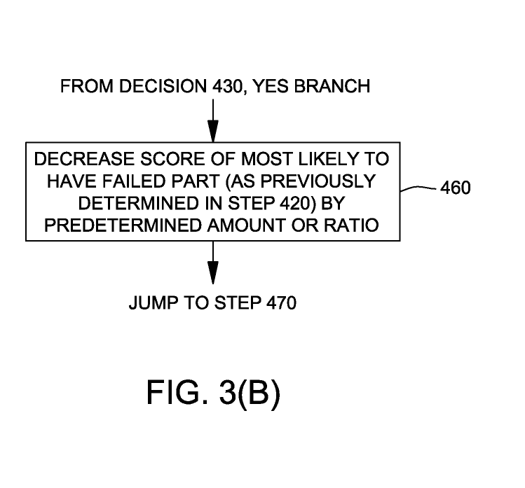

FIGS. 3(A) and 3(B) illustrate the operation and function of another guided repair program 157 in accordance with another embodiment of the present invention, to correct a problem at issue. In step 400, program 157 retrieves a current program report (for a current problem with a product at issue) from file 42. The report identifies a device, such as a computer 32, for which a problem has been reported and the nature/symptoms of the problem. Next, program 157 retrieves from file 41 a list of parts within computer 32 that can be replaced (step 410). Next, program 157 makes a preliminary determination, based on a known algorithm, of the most likely parts in the computer 32 to have failed and thereby caused the problem. In step 420, program 157 also assigns a score to each such part which may have failed, where the higher the score the greater the likelihood that the part has failed. For example, Part D may have a score of “70%”, Part E may have a score of “20%”, and Part F may have a score of “10%”. Next, program 157 determines from the file 44 if the most-likely to have failed part (i.e. the one with the highest score, in this case, Part D) has been replaced in the last predetermined period, such as thirty days (step 422 and decision 430). If not (decision 430, no branch), then program 157 determines that the most-likely to have failed part, as preliminarily determined in step 420 should be replaced first, and proceeds to initiate display of this most-likely to have part as the part to replace first (step 470). This will be Part D in this example. Next, program 157 identifies from file 46 and initiates display of a procedure for replacing Part D (step 472). This procedure is a step-by-step process for removing the old part and installing the replacement part. After the repair person replaces Part D, the repair person notifies program 157, and program 157 records in file 44 that the part has been successfully replaced and the date of replacement (step 473). Also, program 157 identifies from file 48 and initiates display of a procedure for testing whether the replaced part has corrected the problem (step 474). In response, the repair person tests whether the replacement of the part appears to have fixed the problem, and afterwards, notifies program 157 of the results. In response, program 157 records in the corresponding problem report whether the replacement of the part appeared to have fixed the problem (step 478). If the replacement of Part D appears to have fixed the problem, then the repair procedure is complete. However, if the replacement of Part D has not fixed the problem, then program 157 loops back to step 420 to begin another iteration of program 157 for the same problem report. In step 420, program 157 makes a preliminary determination, based on a known algorithm and the nature/symptoms of the problem, of the most likely parts in the computer 32 to have failed and thereby caused the problem. In step 420, program 157 also assigns a score to each such part which may have failed, where the higher the score the greater the likelihood that the part has failed. For example, Part D still has a score of “70%” (because there is not yet consideration of Part D being replaced in the last thirty days), Part E may have a score of “20%”, and Part F may have a score of “10%”. Next, program 157 determines from the parts replacement history file 44 if the most-likely to have failed part (i.e. the one with the highest score, in this case, Part D) has been replaced in the last thirty days (step 422 and decision 430). If not (decision 430, no branch), then program 157 proceeds to step 450 to replace Part E.

However, in this second iteration of program 157 where Part D was just replaced, the answer to decision 430 is “yes”. Likewise, if Part D was replaced earlier, but in the last thirty days, the answer to decision 430 in the first iteration of program 157 is also “yes”. In either case, program 157 proceeds to step 440 to decrease the score of the part that was replaced in the last thirty days (in this example, Part D) by a predetermined amount or percentage, such as fixed amount of 40% (or ½), and increase the scores for the other parts by an equal share of the predetermined amount. In the foregoing example, where the preliminary score for Part D was 70%, the score for Part E was 20% and the score for Part F was 10% during the first iteration, if replacement of Part D did not fix the problem, program 157 reduces the score of Part D to 30%, increases the score for Part E to 40% and increases the score for Part F to 30%. Next, program 157 recomputes the order of the new list of most likely to have failed parts with Part E first, and Parts D and F tied for second place (step 480). Next, program 157 repeats the foregoing steps of FIG. 4 with Part E now as the most likely to have failed part. (In the other example, where the replacement of Part D did not fix the problem, program 157 reduces the score for Part D by ½ and increases the score for Part E by 1/2/2 (or ¼) and increases the score for Part F by 1/2/2 (or ¼). The resultant scores are 35% for Part D, 45% for Part E and 35% for Part F, so the order of replacement is now Part E first, and Parts D and F tied for second.) Consider the case of an intermittent problem where the replacement of Part D during the first iteration of program 157 appears to have fixed the problem as determined from a successful test of the product in step 374 after replacement of Part D. However, replacement of Part D has not really fixed the problem, and the same problem appears again within thirty days. In such a case, Part D will not be replaced again. Instead, Part E will be replaced during the second iteration (assuming Part E was not replaced within the last thirty days), and Part E will most likely fix the problem during the second iteration. The algorithm of program 157 differs from the algorithm of program 157 in that program 157 does not automatically move to the end of the list a part which has been replaced within the last thirty days. This is because it is possible that Part D has failed again, i.e. “infant mortality”, and if the algorithm used in step 420 concludes that Part D is by far the most likely part to have failed (i.e. has a score which is much, much higher than the scores of the other parts in the list), then it will be replaced again even though it was already replaced in the last thirty days.

Programs 57 and 157 can be loaded into server 50 from a computer readable media 80 such as magnetic tape or disk, optical media, DVD, memory stick, semiconductor memory, etc. or downloaded from the Internet via a TCP/IP adapter card 82.

Program 27 can be loaded into server 20 from a computer readable media 28 such as magnetic tape or disk, optical media, DVD, memory stick, semiconductor memory, etc. or downloaded from the Internet via a TCP/IP adapter card 29.

Program 37 can be loaded into server 30 from a computer readable media 38 such as magnetic tape or disk, optical media, DVD, memory stick, semiconductor memory, etc. or downloaded from the Internet via a TCP/IP adapter card 39.

Based on the foregoing, a computer system, method and program product have been disclosed according to the present invention. However, numerous modifications and substitutions can be made without deviating from the scope of the present invention. Therefore, the present invention has been disclosed by way of illustration and not limitation, and reference should be made to the following claims to determine the scope of the present invention.

What is claimed:

1. A computer implemented method for determining an order to replace parts of a product in response to a problem with said product, said method comprising; the steps of:
determining a most likely one of said parts to have failed and caused said problem with said product;
determining a next most likely one of said parts to have failed and caused said problem with said product;
determining if said one part was already replaced within a predetermined period, and
if so, not recommending replacement of said one part and instead recommending replacement of said next part, and
if not, recommending replacement of said one part.

2. A computer implemented method as set forth in claim 1 further comprising the steps of:
replacing first the part recommended for replacement; and
if replacement of the part recommended for replacement does not correct said problem, replacing the other of said parts.

3. A computer program product for determining an order to replace parts of a product in response to a problem with said product, said computer program product comprising:
a computer readable media;
first program instructions to determine a most likely one of said parts to have failed and caused said problem with said product;
second program instructions to determine a next most likely one of said parts to have failed and caused said problem with said product;
third program instructions to determine if said one part was already replaced within a predetermined period, and
if so, not recommend replacement of said one part and instead recommend replacement of said next part, and
if not, recommend replacement of said one part; and wherein
said first, second and third program instructions are stored on said media in functional form.

4. A computer implemented method for determining an order to replace parts of a product in response to a problem with said product, said method comprising; the steps of:
determining a most likely one of said parts to have failed and caused said problem with said product and a first score corresponding to a likelihood that said one part has failed, wherein a higher score indicates a greater likelihood that said one part has failed;
determining a next most likely one of said parts to have failed and caused said problem with said product and a second score corresponding to a likelihood that said next part has failed, wherein a higher score indicates a greater likelihood that said second part has failed;
determining if said one part was already replaced within a predetermined period, and
if so, decreasing said first score by a predetermined amount or percentage and/or increasing said second score by predetermined amount or percentage or fraction thereof, and
if not, maintaining said first score and said second score without change; and
recommending for replacement first whichever of said first part or said second part which has a higher score after the decreasing and increasing step or the maintaining step.

5. A computer implemented method as set forth in claim 4 further comprising the steps of:
replacing first the part recommended for replacement first; and
if replacement of the part recommended for replacement first does not correct said problem, replacing the other of said parts.
